(19) United States
(12) Patent Application Publication
(10) Pub. No.: US 2015/0207160 A1
(43) Pub. Date: Jul. 23, 2015

(54) Fuel Cell Apparatus, Composition and Hydrogen Generator

(71) Applicant: Prometheus Wireless Limited, Worcestershire (GB)

(72) Inventors: Francesco Masetti-Placci, Worcestershire (GB); Stuart R. Barnes, Worcestershire (GB); Ricarda Nothelle, Worcestershire (GB); Saverio Gellini, Worcestershire (GB); Gabriele Tredozi, Worcestershire (GB)

(73) Assignee: Prometheus Wirless Limited, Worcestershire (GB)

(21) Appl. No.: 14/415,043

(22) PCT Filed: Jul. 16, 2013
(86) PCT No.: PCT/GB2013/051905

§ 371 Date: Jan. 15, 2015

(30) Foreign Application Priority Data
Jul. 16, 2012 (GB) 1212636.3

(51) Int. Cl. H01M 8/06; C01B 3/06; B01J 7/02; H01M 8/04; B01J 19/24

(52) U.S. Cl. CPC H01M 8/065; H01M 8/04216; B01J 19/24; B01J 19/2445; B01J 7/02; C01B 3/065; B01J 2219/24; B01J 2219/00094; B01J 2219/00164

(57) ABSTRACT

A fuel cell apparatus comprises fuel cells, hydrogen generators and a control unit. A fuel cell array comprises a plurality of membrane electrode assemblies (MEAs) each having a major planar surface; the MEAs are arranged such that a first surface of a first MEA which is not a major planar surface of the first MEA faces a second surface of a second MEA which is not a major planar surface of the second MEA. A plurality of fuel cells, for example arranged in an array, are included in a blade, which is connected externally to the control unit. The apparatus can accommodate a plurality of blades. A closed reactor for the generation of hydrogen gas from a chemical hydride comprises a reaction vessel; at least one entry port; and an outlet port for outputting hydrogen gas. A unit form of a composition comprises a chemical hydride; the unit form has a volume of at least 0.01 cm3.

### FIELD OF THE INVENTION

The present invention relates to fuel cell apparatuses and hydrogen generators for use with the fuel cell apparatuses, as well as a composition for use in the fuel cell apparatuses.

### BACKGROUND OF THE INVENTION

Currently available fuel cells run on hydrogen or methanol. The hazardous nature of these fuels, and the difficulties associated with containing them safely and securely, usually requires their transport and storage in large cumbersome pressurised tanks, making them unsuitable for use as sources of primary power in remote and mobile applications, and restricting the reliability and scalability of the associated fuel cells.

An alternative to the storage of hydrogen in pressurised tanks is provided by metal hydride cartridges. However, not only do the metal hydrides themselves have a low hydrogen density (i.e. the amount of hydrogen that can be produced per unit volume of fuel is low), but they also require storage in metal containers, thus further reducing the hydrogen density of the fuel source as a whole.

There is therefore a need for an improved hydrogen source for fuel cells, particularly for use in remote and mobile applications.

Existing fuel cells usually comprise a large number of membrane electrode assemblies (MEAs) arranged in a stack. Such a stacked arrangement does not permit ambient air cooling of fuel cells or operation of open cathode fuel cells. It is also known from EP0815609 to provide a flat array of 1-MEA thick fuel cells. However, this results in a very large array which severely restricts the transportability of the fuel cell array and makes the cells impractical for use in many environments where a compact array is desirable.

There is therefore a need for an improved fuel cell array which provides the advantages associated with a flat array whilst allowing for easy transportation and deployment.

Existing fuel cell apparatuses typically have very limited options for reconfiguration and flexibility, making them unsuitable for mobile applications and difficult to package and transport. This is often due to limitations imposed by the necessary interconnections between components within the fuel cell apparatus. The lack of reconfigurability also means that future-proofing of existing fuel cell apparatuses is not possible, since allowances cannot be made for updating and replacement of components.

There is therefore a need for a reconfigurable and flexible fuel cell apparatus.

### SUMMARY OF THE INVENTION

The present invention solves the aforementioned problems and others.

A first aspect of the present invention provides a fuel cell array comprising: a plurality of membrane electrode assemblies (MEAs) each having a major planar surface, wherein the MEAs are arranged such that a first surface of a first MEA which is not a major planar surface of the first MEA faces a second surface of a second MEA which is not a major planar surface of the second MEA. The first and second surfaces may be in contacting juxtaposition.

The “flat” fuel cell array of the present invention allows for ambient air cooling and operation of open cathode fuel cells.

The MEAs may be further arranged such that a major planar surface of the first MEA faces a major planar surface of a third MEA in a stacked arrangement forming a first group of MEAs. The first and third MEAs may each comprise a first major planar surface and a second major planar surface. The first major planar surfaces may be exposed. For example, the first major planar surfaces may be exposed to the surrounding atmosphere, or to air. The first and second major surfaces may be substantially parallel and opposing.

Thus, MEAs within a fuel cell can be arranged “back-to-back”. This allows for open cathode surfaces of neighbouring stacked MEAs within a fuel cell to be exposed to the air, enhancing the possibility of ambient air cooling. Moreover, the open cathodes are exposed to oxygen within the air, which is required for the operation of the fuel cells.

The first group of MEAs may comprise additional MEAs aligned along their major surfaces in a stacked arrangement with the first and third MEAs. The MEAs in the first group may be aligned along their major surfaces in contacting juxtaposition. The first group of MEAs may be a first fuel cell.

The MEAs may be further arranged such that a major planar surface of the second MEA faces a major planar surface of a fourth MEA in a stacked arrangement forming a second group of MEAs. The second and fourth MEAs may each comprise a first major planar surface and a second major planar surface. The first major planar surfaces may be exposed. For example, the first major planar surfaces may be exposed to the surrounding atmosphere, or to air. The first and second major surfaces may be substantially parallel and opposing. The first major planar surface may also be exposed to oxygen within the air.

The second group of MEAs may comprise additional MEAs aligned along their major planar surfaces in a stacked arrangement with the second and fourth MEAs. The MEAs in the second group may be aligned along their major planar surfaces in contacting juxtaposition. The second group of MEAs may be a second fuel cell. The first and second MEAs may be electrically connected in parallel across the first and second surfaces. The first and second MEAs may be electrically connected in series across the first and second surfaces. Each MEA may comprise at least one proton exchange membrane (PEM). The fuel cell arrays may be arranged in a blade.

The major planar surfaces of MEAs within any group may be substantially the same size or may be of different sizes. Moreover, the major planar surfaces of MEAs in different groups of any combination may be substantially the same size or may be of different sizes. MEAs within any group may be the same thickness or may be of different thicknesses. Moreover, MEAs in different groups of any combination may be the same thickness or may be of different thicknesses.

The arrangement of MEAs into a “flat” array of fuel cells, each fuel cell comprising a small stack of MEAs means that the advantages of a flat array (ambient air cooling, oxygen exposure required for open cathode operation) are achieved in a space-efficient and transportable manner.

### Blade Architecture

Another aspect of the present invention provides a fuel cell apparatus comprising: a control unit; and a plurality of fuel cells arranged in a blade, wherein the blade is connected externally to the control unit.

The fuel cell apparatus may further comprise a plurality of blades, where each blade comprises a plurality of fuel cells, wherein the plurality of blades is connected to the control unit. The blades may have a major surface and are arranged such that the major surface of each blade is parallel to the major surfaces of other blades in the plurality of blades, and the control unit resides along surfaces of the blades which are not the major surfaces. The control unit may have a major surface which is substantially perpendicular to the blades.

One or more blades may further comprise additional devices which serve supportive functions. Such devices may include ancillary components such as sensors, probes, buffer batteries, feedback means and minor controls, and may communicate with a control unit as described previously.

The control unit and the plurality of fuel cells may be arranged in a backplane configuration. The control unit may take the form of a backplane.

The control unit may be centrally located between all of the blades in the plurality of blades, such that the blades extend outwards from the control unit around the control unit. The control unit and the plurality of fuel cells may be arranged in a star configuration.

At least one of the blades may be physically and/or electrically disconnectable and/or reconnectable to/from the control unit. At least one of the blades may be electrically and/or physically connectable to the control unit by location of an end of one of the blades into one or more ports located on the control unit. Each of the blades may be compatible for insertion into one of a plurality of ports on the control unit. The ports may be USB ports, microTCA ports and/or advancedTCA ports. The fuel cell apparatus may take the form of a cluster arrangement. The blades and the control unit may communicate via a crossbar switch.

The plurality of fuel cells may be a fuel cell array according to one aspect of the present invention.

The “plug-and-play” configuration of the invention makes the fuel cell apparatus highly advantageous in portable applications, since the apparatus can be dismantled and/or packaged for transportation. For example, the blades can be disconnected from the control unit and stacked on top of one another during transportation and then reconnected to the control unit for deployment of the apparatus. Moreover, the flexible configuration allows for the implementation of different control algorithms within a single flexible architecture.

### Hinged Fuel Cell Apparatus

Another aspect of the present invention provides a fuel cell apparatus comprising a first fuel cell array and a second fuel cell array which are movable with respect to each other between a first configuration and a second configuration, wherein the second configuration is more compact than the first configuration. The first fuel cell array may be foldably connected to the second fuel cell array. For example, the first fuel cell array may be hingedly connected to the second fuel cell array.

The fuel cell apparatus may further comprise a first plurality of fuel cell arrays and a second plurality of fuel cell arrays which are movable with respect to each other between a first configuration and a second configuration, wherein the second configuration is more compact than the first configuration. At least one of the first plurality of fuel cell arrays may be foldably connected to at least one of the second plurality of fuel cell arrays. For example, at least one of the first plurality of fuel cell arrays may be hingedly connected to at least one of the second plurality of fuel cell arrays. The fuel cell arrays in the first plurality of fuel cell arrays and/or the second plurality of fuel cell arrays may be arranged in blades.

In this aspect of the invention, the fuel cell apparatus is “more compact” in the second configuration with respect to the first configuration in the sense that the surface area to volume ratio of the smallest imaginary cuboidal box with dimensions just large enough to contain the fuel cell apparatus in whichever configuration is smaller in the second configuration with respect to the first configuration. Alternatively, the sphericity of the aforementioned imaginary box which just contains the fuel cell apparatus is greater in the second configuration with respect to the first configuration. This may be achieved by moving e.g. folding or sliding or rotating (or a combination of one or more of these) fuel cell arrays or pluralities of fuel cell arrays with respect to each other between the first configuration and the second configuration.

Fuel cell arrays which are foldably connected to each another may be movable with respect to one another about the connection therebetween, such that the fuel cell apparatus is adaptable from a substantially flat configuration to a configuration where fuel cell arrays are stacked on top of one another. Fuel cell arrays which are foldably connected to each other may be foldably connected along a surface which is not a major surface of each fuel cell array. Fuel cell arrays which are foldably connected to each other may be foldably connected along an edge of each said fuel cell array which is an edge of a major surface of said fuel cell array.

The first and second fuel cell arrays may be fuel cell arrays according to an aspect of the present invention.

The “folding” arrangement allows for a fuel cell apparatus which can be folded into a very compact configuration (whilst remaining fully connected) making it highly transportable and suitable for use in mobile applications, such as for carrying in a backpack.

Another aspect of the invention provides a unit form of a composition comprising a chemical hydride, wherein the unit form has a volume of at least 0.01 cm³.

This aspect of the invention also provides the use of the unit form of the invention to generate hydrogen gas in a fuel cell apparatus. The fuel cell apparatus may be as described herein.

This aspect of the invention further provides a method for the generation of hydrogen in a fuel cell apparatus, comprising the step of contacting the unit form of the invention with a fluid. The fuel cell apparatus may be as discussed herein. The fluid is typically water, which may be of any quality and from any source. In one embodiment, the water is selected from deionised water, tap water, river or lake water, and sea water. Liquid water is typically used; steam may also be used.

The provision of the chemical hydride composition in unit form rather than, for example, powder form, gives a product that is easy to store, handle and transport. For instance, it is not necessary to store the unit form in a metal container; it may simply be stored in a plastic wrapping. In addition, the unit form provides a predetermined dose of chemical hydride, thus avoiding the need for a user to measure the correct dose for a given application of, for example, a powder. These features are particularly useful when the unit form is to be used in a mobile fuel cell apparatus, allowing rapid and accurate refuelling of the apparatus in scenarios where use of a powder form would be impractical.

### Unit Form

A “unit form” is a monolithic structure that is capable of being handled, packaged and utilised separately from other unit forms. The unit form has a volume of at least 0.01 cm³. In one embodiment, the unit form has a volume of at least 0.1 cm³, at least 1 cm³, at least 10 cm³, at least 50 cm³, or at least 100 cm³. In one embodiment, the unit form has a volume of less than 1000 cm³, less than 500 cm³, less than 100 cm³, less than 50 cm³, less than 10 cm³, or less than 1 cm³. In a further embodiment, the unit form has a volume of 0.01 cm³ to 1000 cm³, 0.1 cm³ to 500 cm³, 1 cm³ to 100 cm³, or 10 cm³ to 50 cm³. In one embodiment, the unit form has a mass of at least 10 mg, at least 100 mg, at least 1 g, at least 10 g, at least 50 g, or at least 100 g. In another embodiment, the unit form has a mass of less than 1 kg, less than 500 g, less than 100 g, less than 50 g, less than 10 g, or less than 1 g. In a further embodiment, the unit form may have a mass of 10 mg to 1 kg, 100 mg to 500 g, 1 g to 100 g, or 10 g to 50 g.

The unit form may take any shape. The shape may be chosen to facilitate the handling or use of the unit form, e.g. it may be shaped to fit through the entry port of a reactor, or to control its physical properties, such as its rate of dissolution in a solvent. The shape and dimensions of the unit form may conform to the shape and the dimensions of the interior of a portion of the reaction vessel into which it is to be placed. For instance, the lower portion of the reaction vessel is in the form of, or has the shape of, a truncated cone, the unit form may take the shape of a truncated cone having the same cone angle and base diameter as the reaction vessel. Shaping the unit form to fit intimately the interior of the reaction vessel controls the surface area of the unit form that is exposed to fluid introduced into the reaction vessel, thus providing a more gradual and even reaction of the chemical hydride. In addition, shaping the unit form in this way also ensures that as the fluid introduced into the reaction vessel moves downwards under gravity, it will always encounter chemical hydride.

In one embodiment, the unit form is in the shape of a briquette, a brick, a tablet, a flat strip, or a truncated cone.

### Chemical Hydride

A “chemical hydride” is, in a general sense, a compound of hydrogen and one or more elements that are more electropositive than hydrogen, such that one or more hydrogen centres within the compound will have nucleophilic, reducing, or basic properties. A chemical hydride useful in the present invention produces hydrogen upon contact with a fluid (in the presence of a catalyst, if required), typically water. However, in one embodiment, the chemical hydride is not a simple metal hydride, such as sodium hydride, potassium hydride or calcium hydride. Sodium silicide (NaSi, Na₂Si or Na₄Si₄) and aluminium powder may also produce hydrogen upon contact with water, and may therefore be considered as “chemical hydrides” for the purposes of the present invention.

In one embodiment, the chemical hydride is selected from a borohydride and an aluminium hydride.

In another embodiment, the chemical hydride is selected from lithium borohydride (LiBH₄), sodium borohydride (NaBH₄), potassium borohydride (KBH₄), lithium aluminium hydride (LAIN, sodium aluminium hydride (NaAlH₄), a lithium alkoxyaluminium hydride (Li(RO)AlH₃, Li(RO)₂AlH₂ and Li(RO)₃AlH), a sodium alkoxyaluminium hydride (Na(RO)AlH₃, Na(RO)₂AlH₂ and Na(RO)₃AlH), a lithium aminoaluminium hydride, a sodium aminoaluminium hydride, sodium bis(methoxyethoxy)aluminium hydride, diisobutylaluminium hydride (i-Bu₂AlH)₂, aluminium hydride (AlH₃), an aminohydride, an aluminium chlorohydride (AlH₂Cl and AlHCl₂), tetrabutylammonium borohydride (n-Bu₄NBH₄), calcium borohydride (Ca(BH₄)₂), zinc borohydride (Zn(BH₄)₂), sodium cyanoborohydride (NaCNBH₃), tetrabutylammonium cyanoborohydride (n-Bu₄NCNBH₃), zinc cyanoborohydride, cuprous bis(diphenylphosphine) borohydride, cuprous cyanoborohydride, potassium triisopropoxyborohydride (K(i-PrO)₃BH), a lithium aminoborohydride, lithium triethylborohydride (superhydride—LiEt₃BH), lithium tri(s-butyl) borohydride (Li selectride—Li(s-Bu)₃BH), potassium tri(s-butyl) borohydride (K selectride—K(s-Bu)₃BH), a lithium alkylborohydride (e.g. Li(n-Bu)BH₃ and Li 9-BBN—H), borane (BH₃), an amine-borane (R₃N.BH₃), a substituted borane (e.g. diisoamylborane, thexylborane and 9-BBN), an aluminium- or borohydride provided in combination with one or more transition metal salts (e.g. iron, nickel, cobalt, tin, copper or palladium salts, such as CoCl₂, TiCl₃ or NiCl₂), sodium silicide, aluminium powder, and mixtures thereof.

In a further embodiment, the chemical hydride is selected from lithium borohydride (LiBH₄), sodium borohydride (NaBH₄), potassium borohydride (KBH₄), lithium aluminium hydride (LiAlH₄), sodium aluminium hydride (NaAlH₄), a lithium alkoxyaluminium hydride (Li(RO)AlH₃, Li(RO)₂AlH₂ and Li(RO)₃AlH), a sodium alkoxyaluminium hydride (Na(RO)AlH₃, Na(RO)₂AlH₂ and Na(RO)₃AlH), a lithium aminoaluminium hydride, a sodium aminoaluminium hydride, sodium bis(methoxyethoxy)aluminium hydride, diisobutylaluminium hydride (i-Bu₂AlH)₂, aluminium hydride (AlH₃), an aminohydride, an aluminium chlorohydride (AlH₂Cl and AlHCl₂), tetrabutylammonium borohydride (n-Bu₄NBH₄), calcium borohydride (Ca(BH₄)₂), zinc borohydride (Zn(BH₄)₂), sodium cyanoborohydride (NaCNBH₃), tetrabutylammonium cyanoborohydride (n-Bu₄NCNBH₃), zinc cyanoborohydride, cuprous bis(diphenylphosphine) borohydride, cuprous cyanoborohydride, potassium triisopropoxyborohydride (K(i-PrO)₃BH), a lithium aminoborohydride, lithium triethylborohydride (superhydride—LiEt₃BH), lithium tri(s-butyl) borohydride (Li selectride—Li(s-Bu)₃BH), potassium tri(s-butyl) borohydride (K selectride—K(s-Bu)₃BH), a lithium alkylborohydride (e.g. Li(n-Bu)BH₃ and Li 9-BBN—H), borane (BH₃), an amine-borane (R₃N.BH₃), a substituted borane (e.g. diisoamylborane, thexylborane and 9-BBN), an aluminium- or borohydride provided in combination with one or more transition metal salts (e.g. iron, nickel, cobalt, tin, copper or palladium salts, such as CoCl₂, TiCl₃ or NiCl₂), and mixtures thereof.

In another embodiment, the chemical hydride is selected from lithium borohydride (LiBH₄), sodium borohydride (NaBH₄), potassium borohydride (KBH₄), lithium aluminium hydride (LiAlH₄), sodium aluminium hydride (NaAlH₄), calcium borohydride (Ca(BH₄)₂), zinc borohydride (Zn(BH₄)₂), diisobutylaluminium hydride (i-Bu₂AlH)₂, lithium triethylborohydride, and mixtures thereof. In a further embodiment, the chemical hydride is selected from lithium borohydride (LiBH₄), sodium borohydride (NaBH₄), potassium borohydride (KBH₄), lithium aluminium hydride (LiAlH₄) and sodium aluminium hydride (NaAlH₄).

In a specific embodiment, the chemical hydride is sodium borohydride (NaBH₄).

In one embodiment, the chemical hydride within the unit form is in a “compressed form”. A “compressed form” of a chemical hydride is a form that has a greater density than the bulk form of the chemical hydride. The bulk form of a chemical hydride is typically a powder. In one embodiment, the compressed form of the chemical hydride has a density that is at least 65% of the density of the crystalline form of the chemical hydride. In a further embodiment, the compressed form of the chemical hydride has a density that is at least 70%, at least 75%, at least 80%, at least 85% or at least 90% of the density of the crystalline form of the chemical hydride. In a further embodiment, the compressed form of the chemical hydride has a density that is up to 90%, or up to 95%, or up to 99% of the density of the crystalline form of the chemical hydride. In a specific embodiment, the compressed form of the chemical hydride has a density that is 65% to 99%, 70% to 95%, 75% to 90%, 80% to 90%, 85% to 95%, or 90 to 95% of the density of the crystalline form of the chemical hydride. In one embodiment, the whole composition of the unit form is in compressed form, i.e. it has a greater density than the aggregate density of the bulk forms of its components. In one embodiment, the chemical hydride is compressed to a greater degree than the other components. In a further embodiment, only the chemical hydride is in compressed form. This may be achieved by compressing the chemical hydride prior to manufacturing the unit form.

The compressed chemical hydride and the compressed composition may be formed by techniques such as roller compaction, or by using a hydraulic press or a tablet press, such as those used to form coal briquettes or pharmaceutical tablets.

A compressed chemical hydride has the advantage of having a greater hydrogen density than a bulk form, i.e. a greater amount of hydrogen can be produced for a given volume of fuel. This is particularly useful when the unit form is to be used in a mobile fuel cell apparatus as the overall volume of materials carried by a user is reduced.

### Additives

In one embodiment, the composition of the unit form comprises greater than 90 wt % chemical hydride. In an alternative embodiment, the unit form comprises greater than 5 wt %, greater than 10 wt %, greater than 15 wt %, greater than 20 wt %, greater than 25 wt %, greater than 30 wt %, greater than 35 wt %, greater than 40 wt %, greater than 45 wt %, greater than 50 wt %, greater than 55 wt %, greater than 60 wt %, greater than 65%, greater than 70 wt %, greater than 75 wt %, greater than 80 wt % or greater than 85 wt % chemical hydride. In an embodiment, at least 5 wt %, at least 10 wt %, at least 15 wt % or at least 20 wt % of the composition of the unit form is not chemical hydride.

The composition of the unit form may thus comprise at least one additive, such as a tableting aid, in addition to the chemical hydride. In one embodiment, the composition further comprises at least one additive selected from catalysts, carriers, diluents, disintegrants, binding agents and adhesives, wetting agents; lubricants, colorants, buffering agents, and effervescent agents.

The catalysts may be selected from Raney nickel, Pt/C, Ru/LiCoO₂ and Pt/LiCoO₂.

The carriers or diluents may be selected from, either individually or in combination, lactose; starches; mannitol; sorbitol; xylitol; dextrose and dextrose monohydrate; dibasic calcium phosphate dihydrate; sucrose-based diluents; confectioner's sugar; monobasic calcium sulfate monohydrate; calcium sulfate dihydrate; granular calcium lactate trihydrate; dextrates; inositol; hydrolyzed cereal solids; amylose; celluloses; calcium carbonate; glycine; bentonite; block co-polymers; and polyvinylpyrrolidone.

The disintegrants may be selected from, either individually or in combination, starches; clays; celluloses; alginates; crospovidone; and gums.

The binding agents and adhesives may be selected from, either individually or in combination, acacia; tragacanth; sucrose; gelatin; glucose; starches; celluloses; alginic acid and salts of alginic acid; magnesium aluminum silicate; PEG; guar gum; polysaccharide acids; bentonites; povidone; polymethacrylates; hydroxypropylmethylcellulose; hydroxypropylcellulose; and ethylcellulose.

The wetting agents may be surfactants selected from quaternary ammonium compounds; dioctyl sodium sulfosuccinate; polyoxyethylene alkylphenyl ethers; poloxamers; polyoxyethylene fatty acid glycerides and oils; polyoxyethylene alkyl ethers; polyoxyethylene fatty acid esters; polyoxyethylene sorbitan esters; propylene glycol fatty acid esters; sodium lauryl sulfate; fatty acids and salts thereof; glyceryl fatty acid esters; sorbitan esters; tyloxapol and mixtures thereof.

The lubricants may be selected from, either individually or in combination, glyceryl behapate; stearic acid and salts thereof; hydrogenated vegetable oils; colloidal silica; talc; waxes; boric acid; sodium benzoate; sodium acetate; sodium fumarate; sodium chloride; DL-leucine; PEG; sodium oleate; sodium lauryl sulfate; and magnesium lauryl sulfate.

The anti-adherents may be selected from talc, cornstarch, DL-leucine, sodium lauryl sulfate and metallic stearates.

The glidants may be selected from colloidal silicon dioxide, starch, talc, tribasic calcium phosphate, powdered cellulose and magnesium trisilicate.

An aspect of the invention provides a closed reactor for the generation of hydrogen gas from a chemical hydride comprising:
a reaction vessel;
at least one entry port; and
an outlet port for outputting hydrogen gas.

This aspect of the invention further provides a hydrogen generator comprising:
a first reactor comprising the reactor of the invention;
a first dosage device in communication with an entry port of the first reactor; and
a first hydrogen outlet in communication with the outlet port of the first reactor which is connectable to a fuel cell apparatus.

### Reactor

A “closed” reactor is sealed in that, aside from any entry ports, outlet ports or relief valves etc., it is not open to the environment.

In one embodiment, the entry port comprises a lid, i.e. the lid may be opened or removed to allow refueling, then replaced, thus returning the reactor to a “closed” state. This allows easy refilling and emptying of the reactor.

A first portion of the reaction vessel may taper towards a base. This may be the portion of the reaction vessel in which solid chemical hydride is contacted with fluid. As chemical hydride and fluid are typically brought into contact by gravity (i.e. by fluid falling to where chemical hydride resides, or chemical hydride falling to where fluid resides), this first portion is typically a lower portion of the reaction vessel. This means in normal use that the base is closer to the surface of the earth. This shaping provides a larger area higher up the reaction vessel than other shapes, such as cylinders, for a given base surface area, thereby providing more space for the expansion of any foam resulting from the reaction of chemical hydride with fluid (e.g. sodium borohydride with water) without increasing the area of chemical hydride that is exposed to fluid. In one embodiment, the first portion of the reaction vessel is in the form of a frustum. A second portion of the reaction vessel may also be in the form of a frustum. The second portion may be an upper portion, such that the reaction vessel as a whole takes the shape of a bifrustum. The first and second (or lower and upper) portions may be of approximately equal size. In a specific embodiment, the first portion is in the form of a truncated cone. In a further embodiment, the second portion also takes the shape of a truncated cone, such that the reaction vessel as a whole takes the shape of a truncated bicone.

In one embodiment, the entry port is equipped with a fluid distributor. The fluid distributor is placed within the reactor such that it is capable of supplying fluid to the area in which a chemical hydride resides in the reaction vessel (typically the base of the reaction vessel) and may be designed such that it is capable of supplying fluid across the full width of the base of the reaction vessel. In embodiments where the reaction vessel is tapered such that it narrows towards its base (e.g. if the lower portion of the reaction vessel is in the form of a truncated cone), the fluid distributor may be designed such that it is capable of supplying fluid across a width greater than that of the base of the reaction vessel e.g. the diameter of the fluid distributor may be greater than that of the base of the reaction vessel. Therefore, chemical hydride at the bottom of the reaction vessel will be contacted by fluid falling from the fluid distributor and running down the sides of the reaction vessel. The head of the fluid distributor has a plurality of nozzles and may be fixed in one position or may rotate. The head of the fluid distributor may be shaped in the form of conical daisy, i.e. it may comprise limbs radiating outwards from a central point towards one or more interior walls of the reaction vessel. The limbs may lie in a plane parallel to the base of the reaction vessel or may be angled towards the base of the reaction vessel at an angle of up to 45° to the plane parallel to the base of the reaction vessel. A plurality of nozzles is typically distributed along the length of the limbs. The use of a fluid distributor allows a more even or uniform application of fluid to a fuel source than a single fluid input source.

In one embodiment, the reactor comprises a pressure gauge. In a further embodiment, the reactor comprises a pressure relief valve.

The reactor may be of an appropriate size for a given application. For example, a reactor for use with a 50 W fuel cell apparatus may require a daily recharge of 500 g sodium borohydride and 1.3 kg water, thus requiring a reactor size of approximately 2 litres.

In one embodiment, the reactor comprises a catalyst. The catalyst may be deposited on the interior walls of the reactor, or may be fixed in a position within the reactor allowing a greater surface area of the catalyst to come into contact with reactants. The catalyst may be fixed on a carrier, such as a large tube with the catalyst on the inside, allowing the catalysed reaction to take place inside the tube.

In one embodiment, the reactor is adapted for use with the unit form of the invention. In one embodiment, the reaction vessel comprises a unit form of the invention. The shape and dimensions of the unit form may conform to the shape and the dimensions of the interior of a portion of the reaction vessel into which it is to be placed. For instance, if the lower portion of the reaction vessel is in the form of, or has the shape of, a truncated cone, the unit form may take the shape of a truncated cone having the same cone angle and base diameter as the reaction vessel. This may be accomplished by pressing the unit form into shape in situ in the reaction vessel, thus allowing the supply of a reactor pre-loaded with the unit form and avoiding the need for a user to handle the unit form for a first operation of the reactor.

In one embodiment, the reactor comprises a cooling jacket that surrounds at least a portion of the reaction vessel. The cooling jacket is typically supplied with a coolant (e.g. water) such that it is capable of absorbing heat generated by the exothermic reaction in the reaction vessel. The flow rate of the liquid may be controlled such that a constant temperature is maintained within the reaction vessel following the initiation of the exothermic reactor. Cooling the reaction vessel in this way avoids the generation of excessive temperatures that may damage the reactor and reduces the amount of steam and particulates that may be ejected from the reactor along with hydrogen.

In one embodiment, the reaction vessel is a first reaction vessel, and the reactor further comprises a second reaction vessel. The reactor may comprise a first calibrated orifice between the first and second reaction vessels. The reactor may further comprise a second calibrated orifice between the first reaction vessel and the outlet port.

The reactor may further comprise a catalyst in communication with the first calibrated orifice. The reactor may further comprise a collector. The reactor may further comprise a temperature gauge.

### Hydrogen Generator

The hydrogen generator is used to produce hydrogen from a chosen fuel source (e.g. by contacting a chemical hydride with a fluid) for supply to a fuel cell apparatus. The fluid is typically water. However, for some chemical hydrides (e.g. LiAlH₄), ammonia may be used.

The first dosage device may supply a fluid, a chemical hydride (e.g. as a unit form of the invention) or a catalyst to the entry port of the first reactor. In one embodiment, the hydrogen generator further comprises a second dosage device in communication with an entry port of the first reactor. In a further embodiment, the hydrogen generator further comprises a third dosage device in communication with an entry port of the first reactor.

In one embodiment, the first dosage device is a fluid dosage device. This fluid dosage device may be in communication with an entry port of the first reactor equipped with a fluid distributor. The fluid dosage device may be adapted to receive water resulting from the reaction of hydrogen and oxygen in a fuel cell apparatus, enhancing the efficiency of water usage within the system. The fluid dosage device may comprise a restrictor valve to control the rate of fluid delivery to the first reactor. The fluid dosage device may be set to supply fluid to the reactor at a pre-determined rate, or may vary the rate of fluid supply under the control of a control unit, e.g. in response to changes in hydrogen stream pressure.

In a further embodiment, the second dosage is a chemical hydride dosage device. In a further embodiment, the third dosage device is a catalyst dosage device.

In one embodiment, the hydrogen generator further comprises
a second reactor comprising the reactor of the invention, wherein
at least one dosage device is in communication with an entry port of the second reactor; and
a hydrogen outlet is in communication with the outlet port of the second reactor which is connectable to a fuel cell apparatus. In one embodiment, the fluid dosage device is in communication with an entry port of the second reactor. In one embodiment, the first reactor and the second reactor are independently supplied with a fluid from the fluid dosage device. The fluid dosage device may be in communication with an entry port of the second reactor equipped with a fluid distributor.

In one embodiment, the chemical hydride dosage device is in communication with an entry port of the second reactor. In one embodiment, the first reactor and the second reactor are independently supplied with chemical hydride from the chemical hydride dosage device.

In one embodiment, the catalyst dosage device is in communication with an entry port of the second reactor. In one embodiment, the first reactor and the second reactor are independently supplied with chemical hydride from the catalyst dosage device.

In one embodiment, the hydrogen outlet in communication with the outlet port of the second reactor is the first hydrogen outlet. In one embodiment, the first reactor and the second reactor independently discharge hydrogen to the first hydrogen outlet.

In one embodiment, the first and second reactors share a common cooling jacket.

The use of a multi-reactor hydrogen generator allows different reactors to operate in different phases of the hydrogen generation cycle. For instance, one reactor may be generating hydrogen whilst another is being emptied and/or refilled. This arrangement may provide a continuous output of hydrogen at a desired flow rate. Furthermore, independent supply/discharge from each reactor adds a greater degree of control, facilitating the steady-state output of hydrogen and the disposal/recycling of any byproduct of the reaction.

In one embodiment, the hydrogen generator further comprises a separator in communication with the outlet port of the first reactor and the first hydrogen outlet. If the hydrogen generator comprises a second reactor, the separator may also be in communication with the outlet port of the second reactor. The separator removes from the hydrogen stream impurities such as water vapour and particulates of chemical hydride or catalyst that would reduce the efficiency of or damage any fuel cell apparatus connected to the hydrogen generator.

In one embodiment, the hydrogen generator further comprises a heat exchanger in communication with the outlet port of the first reactor and the first hydrogen outlet. If the hydrogen generator comprises a second reactor, the hydrogen heat exchanger may also be in communication with the outlet port of the second reactor. The hydrogen stream leaving the reactor may be at a high temperature as a result of the exothermic reaction in which the hydrogen is generated, and may thus damage a fuel cell apparatus if passed directly to it. The heat exchanger is, therefore, typically a cooler, and may reduce the temperature of the hydrogen stream to less than 90° C., or between 65 and 75° C.

In one embodiment, the separator and the heat exchanger are distinct devices. Alternatively, the separator and the heat exchanger form a combined separator/heat exchanger unit. In other words, one unit performs the role of separator and heat exchanger. This separator/heat exchanger may take the form of a vessel containing a liquid, such as water, through which the hydrogen stream is passed. The separator/heat exchanger may be adapted to receive water resulting from the reaction of hydrogen and oxygen in a fuel cell apparatus, further enhancing the efficiency of water usage within the system. In addition, the separator/heat exchanger may supply water to the fluid dosage device, thus enhancing yet further the efficiency of water usage within the system and allowing for the recycle of particulates of chemical hydride or catalyst to the reactor(s). In one embodiment, the hydrogen generator further comprises a pressure control device in communication with the outlet port of the first reactor and the first hydrogen outlet. If the hydrogen generator comprises a second reactor, the pressure control device may also be in communication with the outlet port of the second reactor. The pressure control device may take the form of a restrictor valve and performs to maintain a steady pressure of the hydrogen stream.

The hydrogen generator may further comprise ancillary components such as probes, sensors, additional control points, intelligent control points, cooling means, pumps and/or feedback means. These additional components may communicate with a control unit as described previously in order to measure, calibrate, optimise, influence and/or maintain certain quantities. These quantities may include reaction vessel pressure, dosage device levels, reaction vessel temperature, hydrogen stream temperature before passage through the separator/heat exchanger or after passage through the separator/heat exchanger, and water level in the cooling jacket.

### BRIEF DESCRIPTION OF THE DRAWINGS

The invention will now be described by way of example with reference to the accompanying drawings, in which:

FIGS. 1a to 1c show schematic views of fuel cells of the present invention;

FIG. 2 is a schematic view of a fuel cell array of the present invention;

FIG. 3 is a schematic view of a blade arrangement of fuel cell arrays of the present invention;

FIG. 4 is a schematic view of a fuel cell apparatus of the present invention;

FIG. 5 is a crossbar switch for use in a fuel cell apparatus of the present invention;

FIGS. 6 to 8 are perspective views of exemplary arrangements of the fuel cell apparatus of the present invention;

FIG. 9 is a cross section of a reactor according to an embodiment of the present invention;

FIG. 10 is a schematic of a hydrogen generator of the present invention;

FIG. 11 is a schematic and operational cycle for a multi-reactor hydrogen generator of the present invention;

FIG. 12 is a schematic of a hydrogen generator of the present invention connected to a fuel cell apparatus;

FIG. 13 is a cross section of a reactor according to another embodiment of the present invention; and

FIG. 14 is a cross section of a reactor according to another embodiment of the present invention.

### DETAILED DESCRIPTION OF THE DRAWINGS

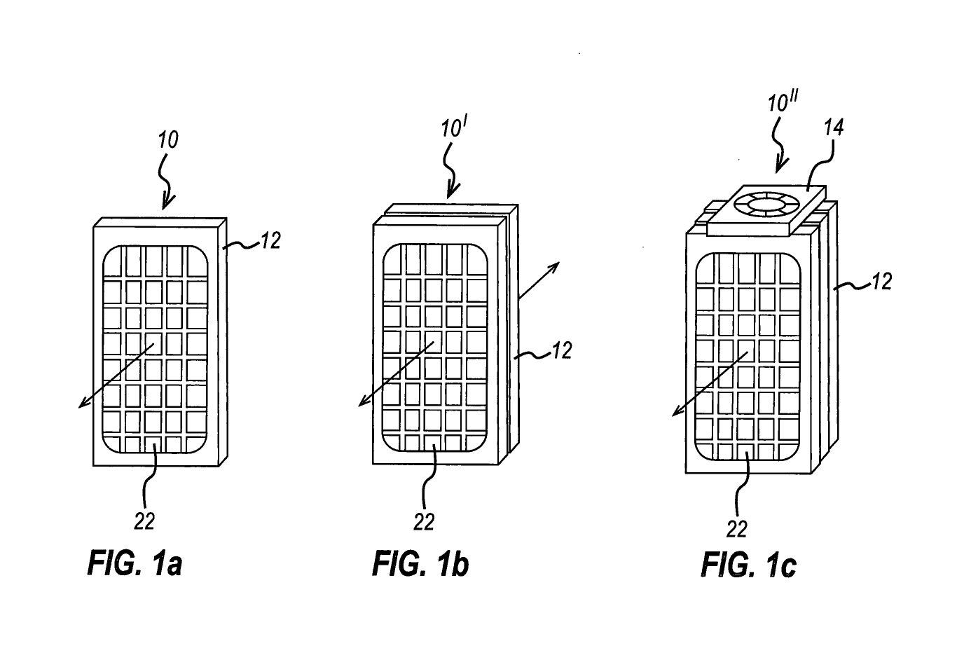

FIGS. 1a to 1c show examples of fuel cells according to an aspect of the present invention. In each of FIGS. 1a to 1c, each layer 12 shown is a single membrane exchange assembly (MEA). FIG. 1a shows a 1-MEA thick cell 10, FIG. 1b shows a 2-MEA thick cell 10′, and FIG. 1c shows a 3-MEA thick cell 10′ with a micro fan 14.

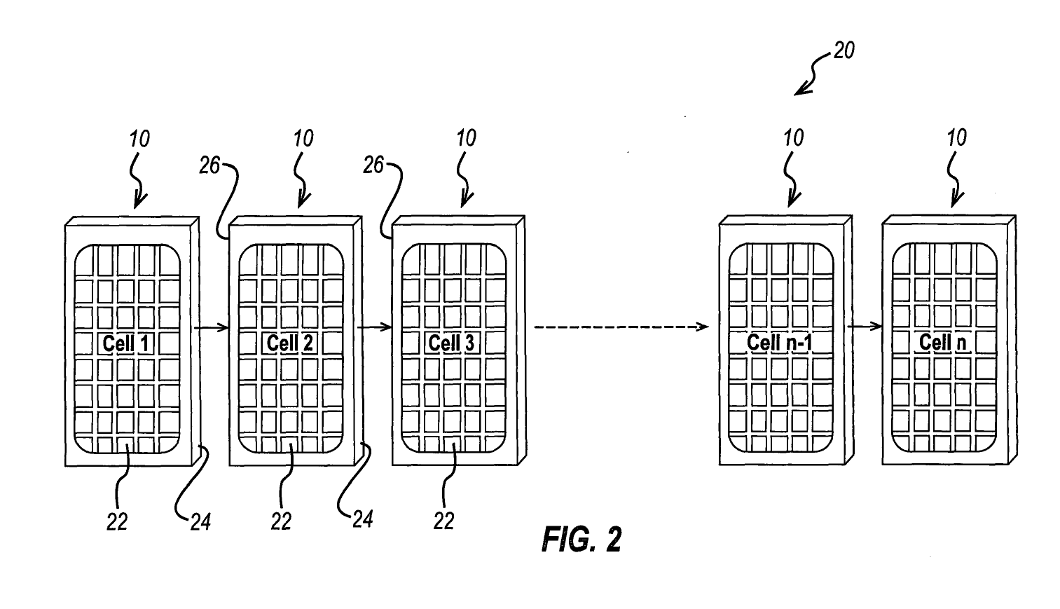

FIG. 2 shows a flat array 20 of 1-MEA thick fuel cells 10. Each MEA has a major planar surface 22, and neighbouring MEAs are arranged such that a first surface 24 of a first MEA 12 which is not a major planar surface of the first MEA faces a second surface 26 of a second MEA 12 which is not a major planar surface of the second MEA. The first 24 and second 26 surfaces are in contacting juxtaposition and electrically connected to one another in series or parallel.

The layout shown in FIG. 2 can also be implemented using 2, 3, . . . , n-MEA thick fuel cells instead of 1-MEA thick fuel cells. MEAs 12 within a fuel cell 10 are arranged in a stacked arrangement and aligned along their major surfaces 22 with their major surfaces 22 in contacting juxtaposition, as shown in FIGS. 1b and 1c. In an exemplary embodiment, two MEAs 12 within a stack each have first and second major planar surfaces which are substantially parallel and opposing, and are arranged such that their first major surfaces are exposed, for example, to the surrounding atmosphere and/or to air (and, therefore, oxygen, which is required for the operation of the fuel cells). In effect, the two MEAs are arranged “back-to-back”. More than one pair of MEAs 12 within a stack can be arranged back-to-back. It is even possible for all MEAs 12 within a stack to be arranged back-to-back, resulting in a stack of MEAs 12 having alternating orientations and with the first and second major planar surfaces of each MEA in contacting juxtaposition, respectively, with first and second major planar surfaces of neighbouring MEAs.

Flow plates (not pictured) are optionally provided through which hydrogen flows to ensure uniform distribution of hydrogen to the MEAs within the fuel cell apparatus. In one example, the flow plates are located at (or fixed on) the edges of the MEAs so as to allow a particularly flat fuel cell arrangement, whilst providing the ability to transfer hydrogen to the MEAs. Alternatively, the flow plates are located alongside or over (or fixed on) a major planar surface of an MEA which is not exposed to the surrounding atmosphere or air, thereby ensuring uniform distribution of hydrogen along the MEA.

In each of the fuel cell arrangements described above, each MEA 12 in turn comprises up to a few proton exchange membrane (PEM) layers internally, but the resulting fuel cell array 20 is still substantially flat. A flat fuel cell array 20 allows for ambient air cooling and operation of open cathode fuel cells by exposing an open cathode to oxygen within the air (particularly when the back-to-back arrangement described above is employed) which is impossible with conventional stacked MEAs.

Although the skilled person will understand that the dimensions of the MEAs can be adjusted to suit particular implementations, MEAs may have a major planar surface area of: 1-100 cm², 5-50 cm² or 10-20 cm², and a thickness of: up to 50 mm, up to 30 mm, up to 20 mm, up to 10 mm, or up to 5 mm.

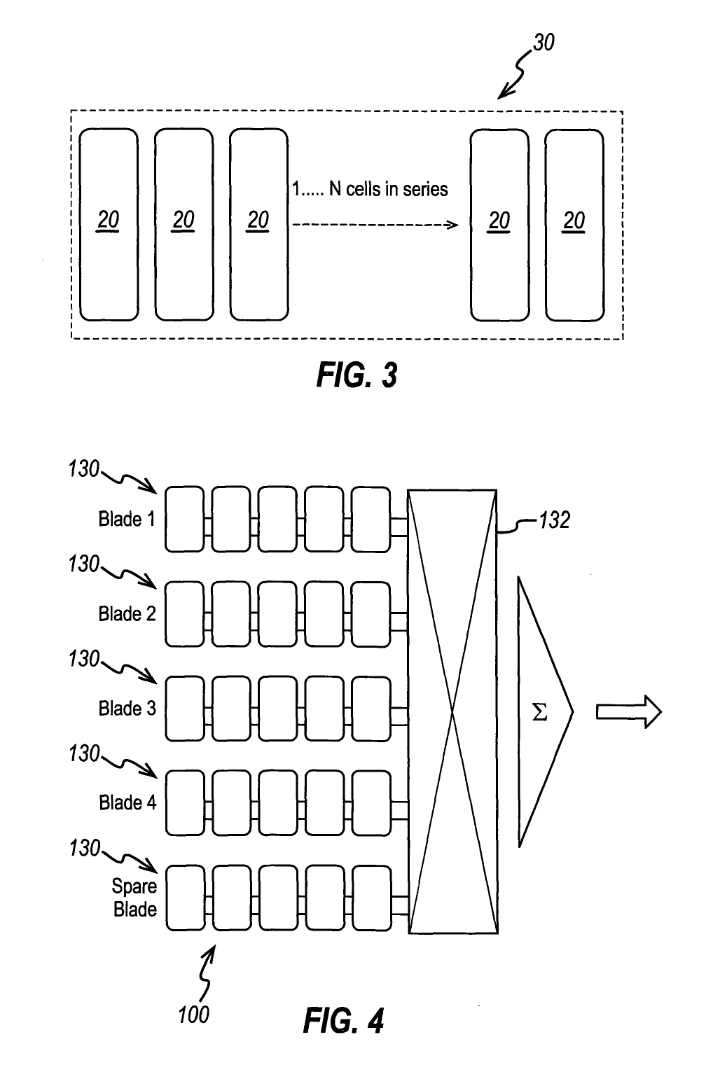

It has been described above that the fuel cells of the present invention are arranged in arrays 20. However, the fuel cells and/or fuel cell arrays themselves are further arranged in blades. A blade includes at least one fuel cell array 20 and additional circuitry (e.g. buffer battery, small control processor, sensors, probes, etc.). Each blade has an electrical power output produced by the fuel cells within the blade, and the blade outputs can be connected to one another in series and/or in parallel. A schematic view of an exemplary blade 30 arrangement is shown in FIG. 3. A small energy storage device (i.e. a battery) is connected to the electrical output of each blade 30 and can function as an energy buffer. This will also help to absorb load peaks, thereby smoothing variations during on/off cycles and collecting and storing excess energy whenever present. It also guarantees minimum operation of the blade 30 in case of failure of the fuel cells, and can aid start-up of the fuel cell apparatus.

The particular arrangement of cells 10 and/or arrays 20 into blades 30 will depend on the performance of each cell 10 and the desired output. Arrays 20 or blades 30 can additionally be arranged back-to-back to increase compactness, leaving the open cathode exposed to the surrounding atmosphere and, in particular, the air (which contains oxygen). Exemplary physical and virtual configurations are discussed below.

According to another aspect of the present invention, there is provided a fuel cell apparatus comprising a control unit and a plurality of fuel cells arranged in a blade, wherein the blade is connected externally to the control unit. The fuel cells can be fuel cells as described above with reference to FIGS. 1a to 1c, and can be arranged in arrays and/or blades as described above with respect to FIGS. 2 and 3.

The structure of the fuel cell apparatus is based on the idea of a “cluster” arrangement. In a cluster arrangement, component batteries are electrically and/or physically connected together directly (in a traditional manner) or using a network/switching matrix, or a hybrid combination of both. The components of a cluster arrangement are connected to each other, but each component is capable of running independently, allowing for distributed, scalable operations.

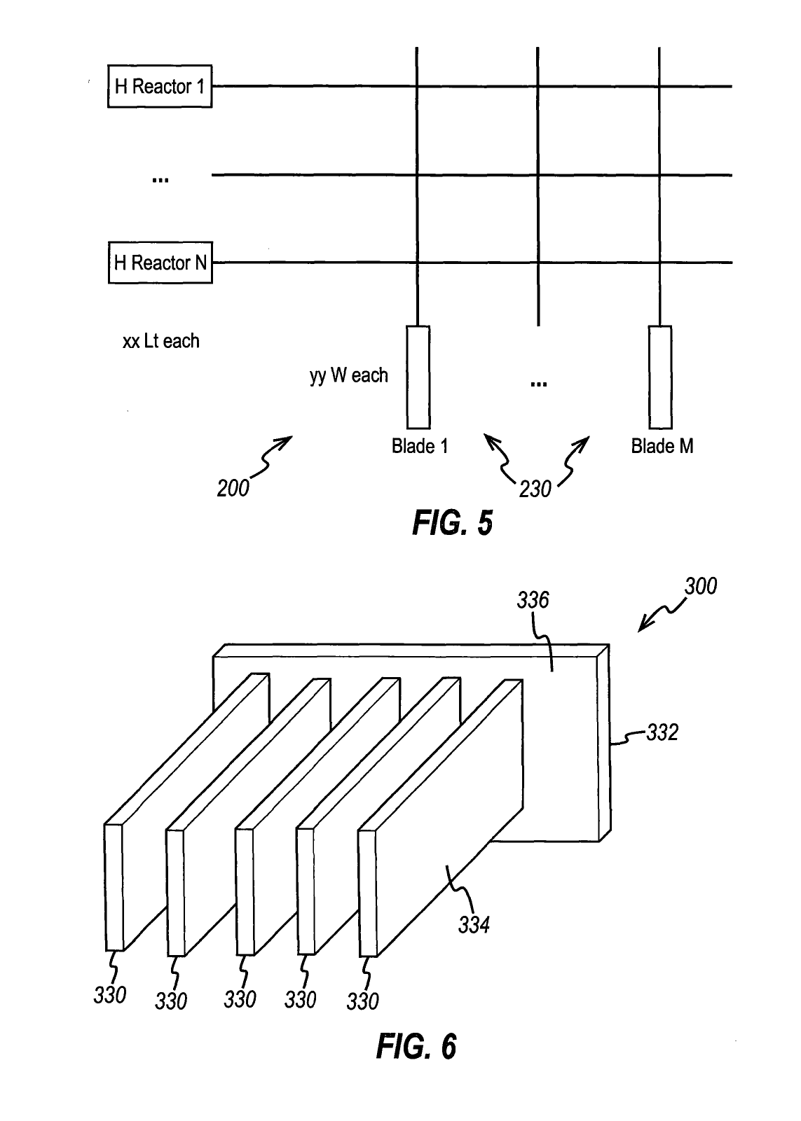

FIG. 4 shows a fuel cell apparatus 100 comprising a plurality of blades 130 connected to a control and/or switching unit 132. The apparatus 100 shown in FIG. 4 comprises four main blades and a spare blade, which can be deployed in case of a high output demand or failure/poor performance of one of the main blades. The blades 130 have an electrical power output, representing the component batteries in the cluster arrangement, and are physically located together and/or closely coupled together. All of the blades 130 are connected as inputs to a crossbar switch (or a matrix switch, as it is more commonly called in this application), which is used to interconnect flexibly every blade 130 to a set of common points in the apparatus 100. A schematic view of an exemplary crossbar switch 200 is shown in FIG. 5. The overall power on output to an external electrical device is the sum of the energy produced by the blades 230 switched “on” at a single moment.

The “intra-cluster” interconnection can be reconfigurable, allowing for future-proofing of the system, as well as built-in reliability and longevity which can be supported by appropriate modelling and, for example, addition of spare component batteries inside the overall architecture.

As a result of the crossbar interconnection, the control unit, with the use of appropriate algorithms and scheduler, is able to monitor the blade operation and is able to switch on blades (and corresponding fuel) when a load is present, and switch off blades (and corresponding fuel) when the load decreases. In addition, the control unit is able to switch off blades which do not meet expected performance levels (e.g. failures, poor life cycle) and switches on spare blades as required and/or available. The control unit is additionally able to:
Monitor the load condition and control the number of blades that are needed by turning on/off electrical connectivity and hydrogen supply to each individual blade;
Monitor the water and compound fuel levels in a hydrogen generator which forms an input, produce statistics and send out alarms when critical levels are met;
Monitor hydrogen pressure for each blade and ensure control of the hydrogen dosage/level accordingly;
Monitor other sensor signals (e.g. air flow, temperature, voltage, amperage) of each blade, producing statistics and sending out alarms when critical levels are met;
Provide reporting function to indicators or other output source, supporting regular administration and maintenance (OAM) functionalities.

System control and sensor signals can be exchanged through an interface between each blade with a main system support unit (e.g. a USB or CAT5 interface). Sensor signals can include, for example, temperature, pressure, voltage and amperage.

A purge function can optionally be implemented to empty and/or clean the system at regular intervals or on command. Arranging fuel cells in blades as described herein provides control functionality of the above features and implementation of the overall system control.

One or more blades may further comprise additional devices which serve supportive functions. Such devices may include ancillary components such as sensors, probes, buffer batteries, feedback means and minor controls, and may communicate with a control unit as described previously.

As described previously, a battery (not shown) can also be connected to the electrical power output of one or more of the blades, and can have the advantageous effects of aiding start-up of the apparatus, acting as a regulator in controlling the apparatus, and smoothing out dips in the power delivered by the fuel cell apparatus. A battery can also guarantee minimum operation of a blade in case of failure of the fuel cells within the blade.

The fuel cell apparatus according to the present invention can be arranged into a number of physical configurations, for example, to accommodate various power/voltage requirements, various form factors, different packaging and packaging materials, different operating conditions, and application-specific physical constraints.

In many applications, it is preferable for one, some, or all of the blades to be physically and/or electrically disconnectable and/or reconnectable to/from the control unit, since this allows for an entirely rearrangable, reconfigurable, “plug-and-play” configuration. For example, the blades can be electrically and/or physically connectable to the control unit by location of an end of one or more of the blades into one or more ports located on the control unit. This makes the fuel cell apparatus highly advantageous in portable applications, since the apparatus can be dismantled and/or packaged for transportation. For example, the blades can be disconnected from the control unit and stacked on top of one another during transportation and then reconnected to the control unit for deployment of the apparatus. The blades can, for example, be insertable into and removable from ports in the control unit, such as USB ports. The apparatus can also be microTCA or advancedTCA compatible. Any other suitable connection means between the blades and the control unit could equally be employed.

As described previously, the apparatus can comprise “spare” blades which are physically and/or electrically disconnectable and/or reconnectable to/from the control unit in series and/or in parallel with “active” blades. All active blades have an electrical power output produced by the fuel cells within the blade. In the event of one of the active blades becoming faulty and/or performing below required performance levels (e.g. power output), the redundancy achieved by the provision of one or more spare blades means that the faulty or badly-performing blade can be replaced with a spare blade without the need to shut down the apparatus.

Some exemplary physical configurations of the blades and control unit are now described, although it will be evident to the skilled person that any number of other configurations could equally be employed.

A first exemplary physical configuration 300 is shown in FIG. 6. This configuration 300 is a “backplane” configuration, with the control unit 332 taking the form of a backplane. The apparatus 300 comprises a plurality of blades 330, where each blade 330 comprises fuel cells 310, and each of the plurality of blades 330 is connected to the control unit 332, for example, as described above. Each of the blades 330 has a major surface 334 and the blades 330 are arranged such that the major surface 334 of each blade 330 is parallel to the major surfaces 334 of other blades 330. The control unit 332 resides along surfaces of the blades 330 which are not the major surfaces 334, and has a major surface 336 which is substantially perpendicular to the blades 330. Although FIG. 5 shows blades 330 which are equally-spaced along the backplane 332, this is not necessarily the case, and any special arrangement of the blades 330 along the backplane 332 can alternatively be used.

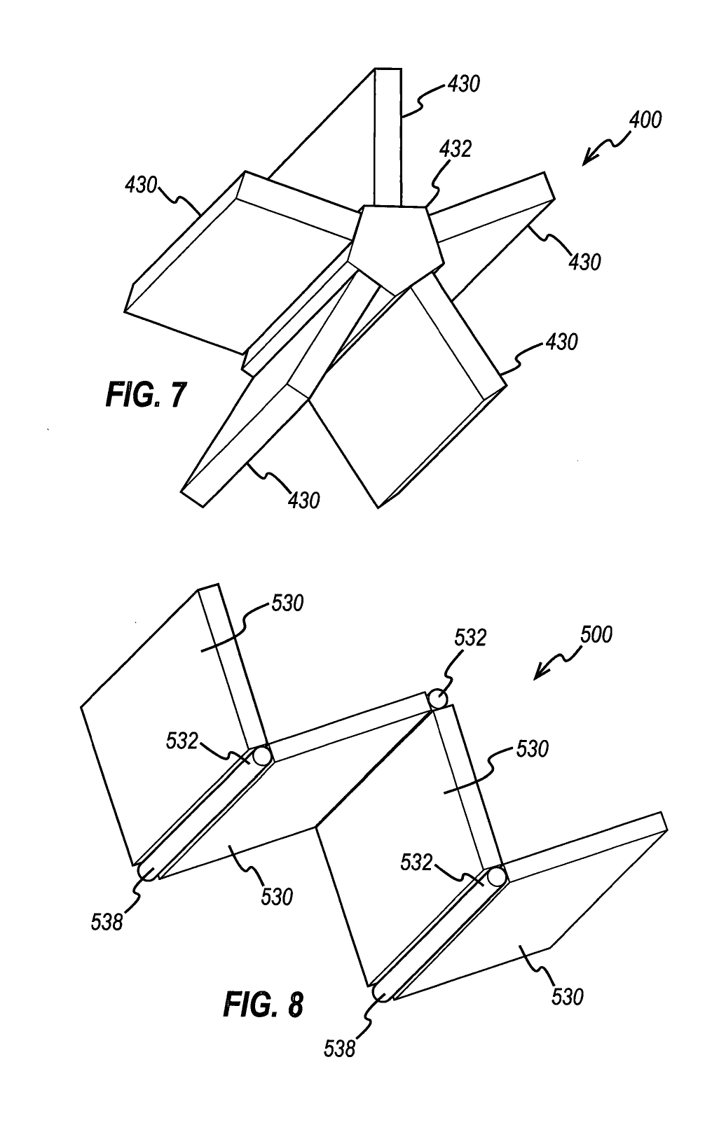

A second exemplary physical configuration 400 is shown in FIG. 7. This configuration 400 is a “star” configuration, with the control unit 432 taking the form of a central pillar. The control unit 432 is centrally located between the blades 430, such that the blades 430 extend outwards from the control unit 432 around the control unit 432. Although FIG. 6 shows blades 430 which are equally-spaced around the central control unit 432, this is not necessarily the case, and any arrangement of the blades 430 around the central unit 432 can alternatively be used.

It is advantageous to provide a fuel cell apparatus which is movable from a less compact configuration to a more compact configuration and vice versa. The fuel cell apparatus is “more compact” in a second configuration with respect to a first configuration in the sense that the surface area to volume ratio of the smallest imaginary cuboidal box with dimensions just large enough to contain the fuel cell apparatus in whichever configuration is smaller in the second configuration with respect to the first configuration. Alternatively, the sphericity of the aforementioned imaginary box which just contains the fuel cell apparatus is greater in the second configuration with respect to the first configuration. This may be achieved by moving e.g. folding or sliding or rotating (or a combination of one or more of these) fuel cell arrays or pluralities of fuel cell arrays with respect to each other between the first configuration and the second configuration.

An exemplary physical configuration 500 is shown in FIG. 8. In this embodiment, the fuel cell apparatus is movable from an unfolded configuration to a folded configuration. Fuel cells are arranged in fuel cell arrays and blades 530 as described hereinbefore. However, in this embodiment, blades 530 are foldably or hingedly connected to each other along an edge of each blade 530. The folding connection 538 means that connected blades 530 are rotatable with respect to one another (e.g. their major surfaces) about the connection 538 therebetween by an angle of up to 45°, up to 90°, up to 135°, or up to 180°, such that the fuel cell apparatus 500 is adaptable from a substantially flat configuration to a configuration where blades 530 are stacked on top of one another. This allows for a fuel cell apparatus 500 which can be folded into a very compact configuration (whilst remaining fully connected) making it highly transportable and suitable for use in mobile applications, such as for carrying in a backpack. Control units 532 can be provided at the hinged interconnections 538 between blades, in which case a crossbar switching interconnection, such as that described previously, can be provided allowing each control unit to communicate with every blade in the folding fuel cell apparatus.

The fuel cell apparatus requires a source of hydrogen and a source of oxygen to operate. The oxygen source is typically air, e.g. an opening may be included in the fuel cell apparatus. Pressurized tanks may be used as the hydrogen source although, as discussed above, there are disadvantages associated with the transportation and storage of such tanks. Hydrogen may instead be generated where it is needed and when it is needed from a suitable fuel source using the apparatus described below.

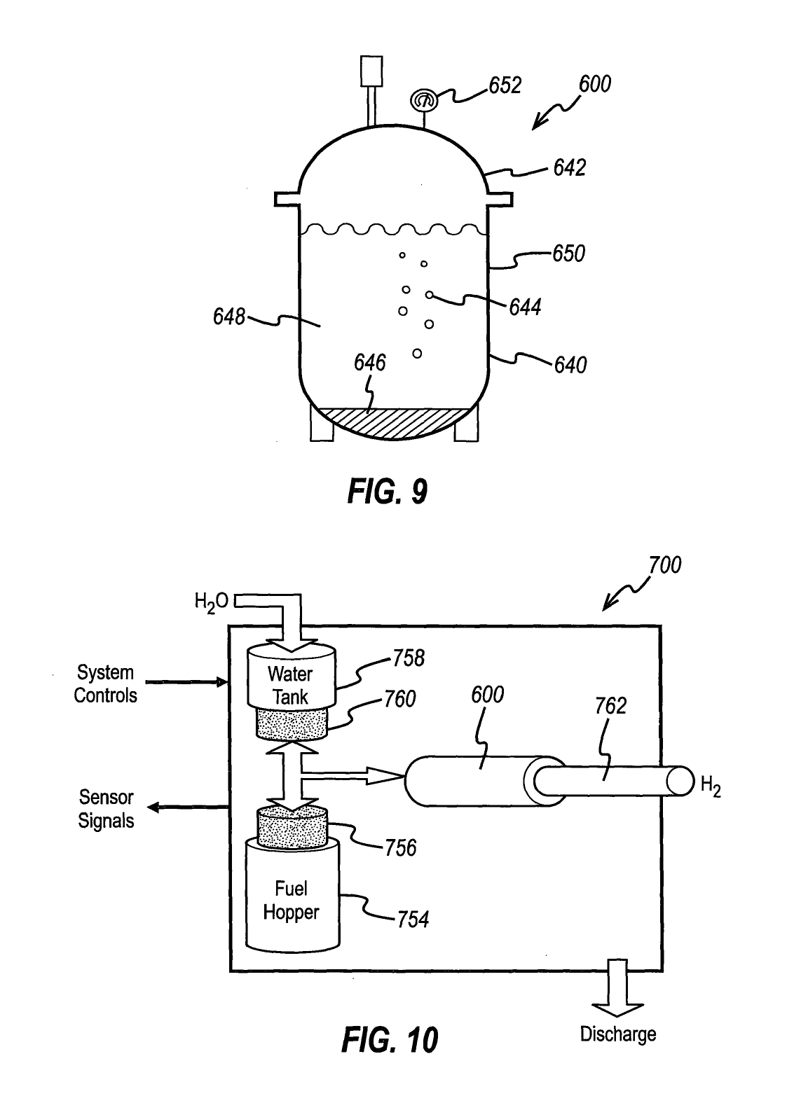

FIG. 9 shows a reactor 600 of the invention. The reactor 600 is compact and of a smooth round shaped interior, avoiding nooks and tight passages to facilitate the process of mixing and dispersing reactants. The exterior may be fitted with suitable handles, a flat base to allow for secure placing on the ground, and guide rails to fit into a housing.

The reactor 600 shown is opened for recharging and therefore consists of a main body 640 and a lid 642. The lid 642 is dome shaped and can be screwed on and off without any tools (e.g. it may employ wing nuts or food industry grade flanges). The reactor 600 is shaken vigorously manually upon recharge to disperse the solid fuel in the water, avoiding the need for an electrically powered dispersing device. Once the reaction has started, the rising hydrogen 644 will cause enough agitation in the reactor 600 to ensure that sufficient mixing occurs to maintain a steady rate of reaction. The hydrogen 644 will rise to the top of the reactor 600, from where it can proceed to a fuel cell array. As hydrogen is much lighter than air, little air that resides in the reactor from the recharging will actually get to the fuel cell array. The reaction product 646 (e.g. borax where sodium borohydride is used as the fuel) is typically much heavier than the fuel and will thus sink to the bottom of the reactor 600, where it does not interfere with the reaction. When the reaction is complete, the lid 642 may be removed to empty out water and reaction products.

A circulatory flow may be maintained in the reactor 600 by placing any catalyst and any heating coils in the lower centre of the vessel. The rising bubbles of the hydrogen 644 and the warmer dispersion 648 will rise and thus initiate and maintain an upward current in the vessel. The fluid then has no other way to go down than at the periphery and a circular motion will be established: centre up, down along the walls 650.

Chemical hydride or water can be used in excess. Water excess allows efficient fuel usage and easy discharge of reaction products. Chemical hydride excess allows re-use of the unit form.

The reactor lid 642 is fitted with a connector pipe that allows the hydrogen to flow to a fuel cell array. Between the connector and the main unit there may be separator to hold back any water droplets, with an integrated heat exchanger to remove steam (water trap). This separator can simply consist of a siphon and wire mesh or similar, allowing the water to simply drip back into the reactor. This arrangement requires that the water trap is to be located above the reactor. A hydrogen check valve may be located between the reactor 600 and a fuel cell array. The hydrogen connector may be of plug-in type, thus requiring no tools for fastening/unfastening.

The pressure gauge 652 on the reactor 600 allows a user to check whether the reactor 600 is pressure-free before unscrewing and whether the reactor 600 is securely screwed shut and no leakage occurs after recharging.

The reactor 600 may be made from a polymer material, aluminium or stainless steel to ensure light weight and portability. The sensors and connectors are typically steel.

In an exemplary embodiment using the reactor 600 of FIG. 9, the recharging procedure comprises the following steps:
1. Close hydrogen valve
2. Check if pressure is zero
3. Unplug hydrogen connector
4. Remove reactor from housing
5. Unscrew reactor lid
6. Discard exhausted fuel/water mixture
7. Empty one bag of sodium borohydride and one bag of catalyst into the reactor
8. Fill up with water to the marked level
8. Screw lid on
9. Shake well for a certain time
10. Replace into housing
11. Connect hydrogen connector
12. Open hydrogen valve

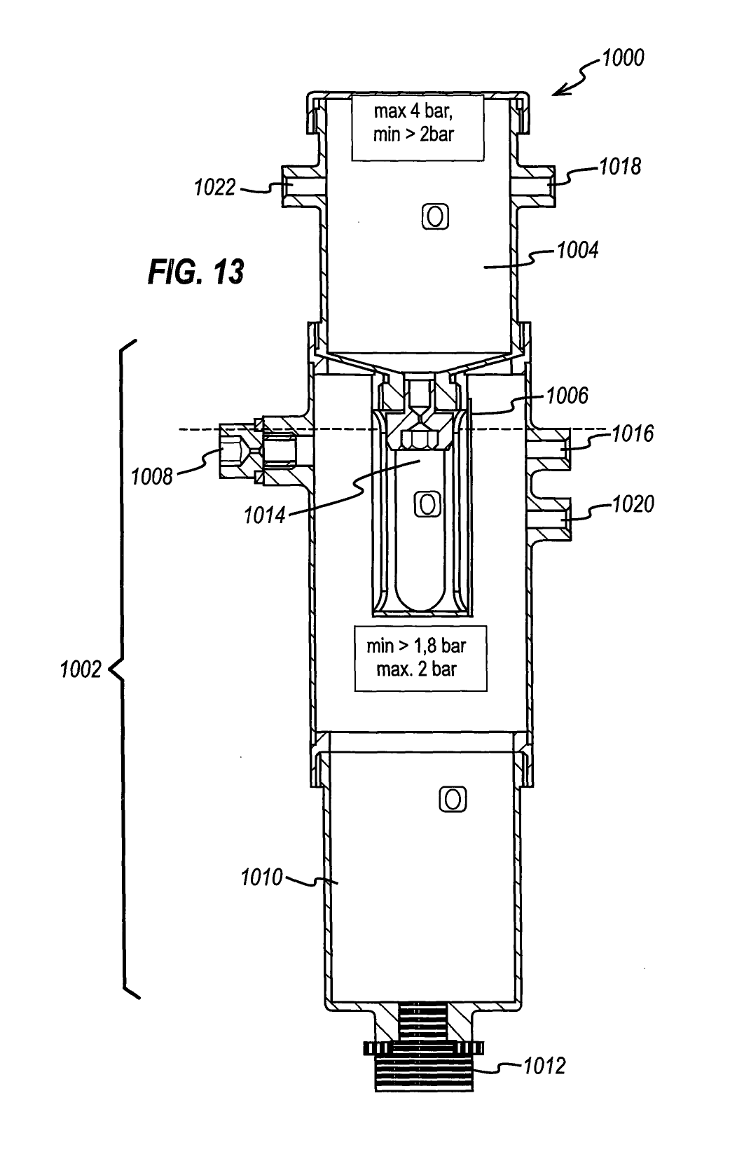

FIG. 13 shows another exemplary reactor 1000 of the invention. The reactor comprises a first reaction vessel 1002 (“main reaction vessel”) and a second reaction vessel 1004 (“pre-reaction vessel”) in fluid communication with the first reaction vessel 1002. The reactor 1000 further comprises a first calibrated orifice 1006 between the first 1002 and second 1004 reaction vessels. The first calibrated orifice 1006 is a conduit or passageway which can be adjusted to allow the reaction solution to flow through it at a predetermined “flow rate” and at pressure (e.g. max. 4 bar). In an exemplary embodiment, the first calibrated orifice 1006 has a diameter of 0.4 mm and effects a pressure change of 2 bars. An exemplary flow rate through the first calibrated orifice 1006 is 120-130 cc/hour.

The reactor 1000 further comprises a second calibrated orifice 1008 between the first reaction vessel 1002 and an outlet port of the reactor 1000. The second calibrated orifice 1008 is a conduit or passageway which can be adjusted to allow hydrogen to flow through it at a predetermined “flow rate” from the reactor 1000 to a fuel cell (not shown).

The reactor 1000 further comprises a catalyst 1014. The catalyst is contained within a canister. The external surfaces of the canister are made of a mesh, fine enough to prevent catalyst from passing through the mesh. Reaction solution will pass through the catalyst 1014 in random ways, in principle getting in touch with the whole surface to optimize the hydrogen production rate. Progressively, the canister will be submerged by the reaction solution, and the catalyst will be soaking into solution, optimizing the hydrogen generation rate.

The first reaction vessel 1002 comprises a first pressure sensor 1016 and a first temperature sensor 1020. The second reaction vessel 1004 comprises a second pressure sensor 1018 and a second temperature sensor 1022. Additional pressure sensors and/or temperature sensors can be provided.

A collector 1010 in the form of a collection bin is provided at the base of the first reaction vessel 1002 to collect by-products of the reaction. A drain tap 1012 is also provided at the base of the reactor.

In use, water and sodium borohydride are pre-loaded into the second reaction vessel 1004. The reaction begins without a catalyst and generates sufficient pressure (e.g. max. 4 bar) to cause reaction solution to pass through the first calibrated orifice 1006 from the second reaction vessel 1004 to the first reaction vessel 1002. The reaction solution can then make contact with the supported catalyst 1014.

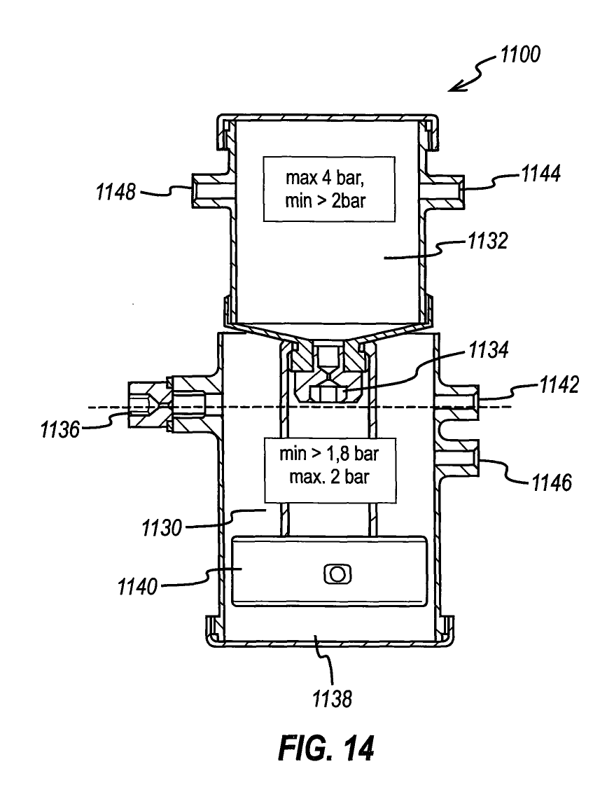

FIG. 14 shows another exemplary reactor 1100 of the invention. The reactor comprises a first reaction vessel 1130 (“main reaction vessel”) and a second reaction vessel 1132 (“pre-reaction vessel”) in fluid communication with the first reaction vessel 1130. The reactor 1100 further comprises a first calibrated orifice 1134 between the first 1130 and second 1132 reaction vessels. The first calibrated orifice 1134 is a conduit or passageway which can be adjusted to allow the reaction solution to flow through it at a predetermined “flow rate” and at pressure (e.g. max. 4 bar). In an exemplary embodiment, the first calibrated orifice 1134 has a diameter of 0.4 mm and effects a pressure change of 2 bars. An exemplary flow rate through the first calibrated orifice 1006 is 120-130 cc/hour.

The reactor 1100 further comprises a second calibrated orifice 1136 between the first reaction vessel 1130 and an outlet port of the reactor 1100. The second calibrated orifice 1136 is a conduit or passageway which can be adjusted to allow hydrogen to flow through it at a predetermined “flow rate” from the reactor 1100 to a fuel cell (not shown).

The reactor 1100 further comprises a catalyst 1140. The catalyst is contained within a canister. The external surfaces of the canister are made of a mesh, fine enough to prevent catalyst from passing through the mesh. Reaction solution will pass through the supported catalyst 1140 in random ways, in principle getting in touch with the whole surface to optimize the hydrogen production rate. Progressively, the canister will be submerged by the reaction solution, and the catalyst will be soaking into solution, optimizing the hydrogen generation rate.

The first reaction vessel 1130 comprises a first pressure sensor 1142 and a first temperature sensor 1146. The second reaction vessel 1132 comprises a second pressure sensor 1144 and a second temperature sensor 1148. Additional pressure sensors and/or temperature sensors can be provided.

A collector 1138 in the form of a collection tray is provided at the base of the first reaction vessel 1130 to collect by-products of the reaction.

FIG. 10 shows a hydrogen generation apparatus 700 of the invention. The apparatus 700 includes systems to monitor and control the rate of addition or dosage of water and chemical hydride and also the reaction rate, temperature, and pressure within the apparatus.

The fuel hopper 754 contains the chemical hydride solid fuel. The level or weight is monitored and an alarm sent when a) the level gets low, b) the hopper 754 is empty. Addition of the solid fuel to the reactor is performed by the fuel dosage device 756, which may employ a conveyer screw, rotary valve, helical screw or any other suitable (semi-continuous) dosing techniques.

The water tank 758 contains the water needed for the reaction, and its level is monitored to send an alarm when a) the level gets low, b) the tank is empty. Addition of water to the reactor 600 is performed by the water dosage device 760 and may be continuous or semi-continuous, i.e. in intervals. This can be accomplished by on/off or dosing valve or plunger pump or by other suitable dosing techniques.

The dimensions of the fuel hopper 754 and the water tank 758 will vary according to the application and the maintenance intervals. The reactor 600 may be of the design discussed above or may be of a different design.

Water and chemical hydride solid fuel are supplied to the reactor 600 by the water 760 and fuel 756 dosage devices, wherein they react to generate hydrogen. The rates of addition of water and chemical hydride by the dosage devices may be pre-set by the manufacturer, or manually set by a user, or controlled by feedback from the monitoring systems of the fuel hopper 754, the water tank 758, and/or the reactor 600. Supply of the reactants may continue until either or both is exhausted, or until the dosage devices are deactivated after a pre-set interval, or by a user, or by the monitoring systems.

Hydrogen leaves the reactor 600 via the hydrogen outlet 762, which is a connector tube with pressure reduction valve to avoid over-pressurisation of a fuel cell array as it is safer not to store large amounts of hydrogen at any one time.

Reaction products of the hydrogen generation (e.g. borax) can be removed from the reactor 600 mechanically or by manually emptying it as described above. The reaction products may be discharged into the environment (e.g. in military applications) or recycled locally (in small amounts). For nomadic or semi-stationary applications, large amounts cannot be released into the environment, and reaction product recovery is required e.g. in a holding tank.

In an exemplary embodiment, the hydrogen generation apparatus of the invention comprises more than one reactor. The fuel dosage device and water dosage device are in communication with an entry port of each reactor, and the hydrogen outlet is in communication with an outlet port of each reactor. The hydrogen outlet is connectable to a fuel cell apparatus, such as the fuel cell apparatus described above. The reactors are independently supplied with fuel from the fuel dosage device and water from the water dosage device. The reactors also independently discharge hydrogen to the hydrogen outlet.

The provision of more than one reactor which are all independently supplied with fuel and water and which independently discharge hydrogen means that the reactors are able to operate independently of each other. This means that hydrogen generation by the hydrogen generation apparatus can be continuous, since a reaction can be taking place in one reactor whilst another reactor is being discharged or loaded. Therefore, it is possible to sequence the operation of the reactors in such a way that a reaction is always taking place in at least one reactor and thus hydrogen generation is uninterrupted.

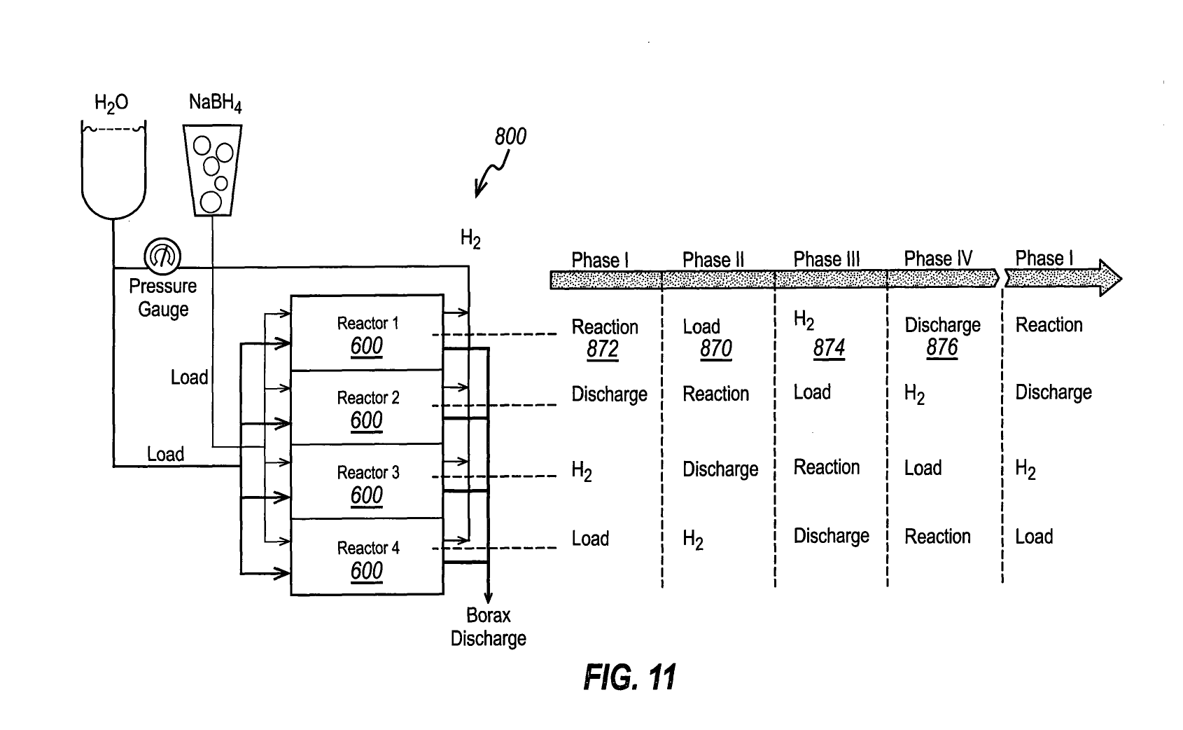

This concept is shown in FIG. 11. The apparatus 800 shown in FIG. 11 comprises four reactors 600, which may be the reactor 600 described above and shown in FIG. 9. It will be understood that any number of reactors 600 can equally be used. The steps of loading fuel and water 870, initiating the reaction 872, outputting hydrogen gas 874 and discharging the reaction products 876 are sequenced in four phases such that hydrogen gas is being generated by at least one of the reactors at any given moment. Hence, advantageously, there is no “dead” time when no hydrogen gas is being produced and hydrogen gas can be produced at a desired flow rate.

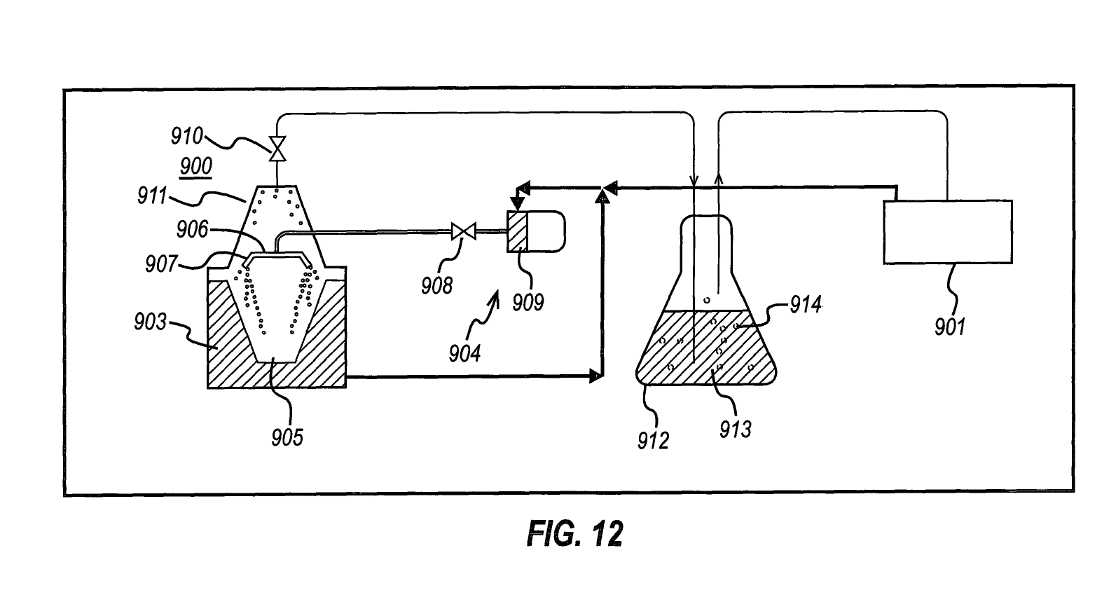

FIG. 12 shows hydrogen generation apparatus 900 connected to fuel cell apparatus 901. Reaction vessel 902 is shaped as a truncated bicone and is placed within cooling jacket 903, which contains water. The outer wall of reaction vessel 902 is in contact with water, thus dissipating the heat generated by the reaction within reaction vessel 902. Cooling jacket 903 is connected to water dosage device 904 such that it can be used as a source of water for the reaction in scenarios where water is scarce.

At the bottom of the lower portion of reaction vessel 902 is unit form 905 of chemical hydride (e.g. NaBH₄) and catalyst that has been pressed into a truncated cone shape with a cone angle the same as that of reaction vessel 902. This shape of unit form 905 allows the gradual and/or even consumption of the chemical hydride during the reaction with water injected by distributor 906 and ensures that the bottom of reaction vessel 902, where the water will generally be, is readily filled up with chemical hydride.

Distributor 906 is shaped in the form of conical daisy, which is directed down towards the base of reaction vessel. The petals (i.e. limbs) 907 of the daisy are rectangular, narrow and elongated. The water falling between one petal and the next onto unit form 905 divides it into sectors where the reaction happens. In addition, water that reaches the distal end of each daisy petal will fall over the conical wall of reaction vessel 902 and then runs down the surface to come in contact, and react, with the chemical hydride lying against the walls of reaction vessel 902.

Pre-calibrated restrictor/valve 908 (schematically shown by a simple valve) is used for the dosing of the water flow necessary to control the chemical reaction. Water is stored in accumulator/vessel 909, which is pressurised with an external manual pump. The feeding of water into reaction vessel 902 is achieved by the internal pressure within accumulator/vessel 909.

Pre-calibrated restrictor/valve 910 (schematically shown by a simple valve) controls the pressure of the hydrogen stream passed from reactor 911 to separator/cooler 912 to maintain a constant pressure of hydrogen ultimately supplied to fuel cell apparatus 901.

Separator/cooler 912 contains water 913 through which the hydrogen stream is bubbled 914 to cool it and to remove impurities, such as particulates from reaction vessel 902 and water vapour. Hydrogen is then collected in the upper part of separator/cooler 912 to be fed to fuel cell apparatus 901.

The water created by contact of hydrogen and oxygen in fuel cell apparatus 901 condenses on the external surface of each fuel cell. A drainage system collects this condensation water downstream of each fuel cell and recycles it to hydrogen generation apparatus 900 (specifically to water dosage device 904 in the schematic), further enhancing the efficiency of water usage within the system.

In a 50 W system, NaBH₄ may be supplied to reaction vessel 902 at 60 g/hour, catalyst at 1 g/hour and water at 100 g/hour. Hydrogen is thus evolved at 50 l/hour (or 4.16 g/hour) from reaction vessel 902, entering separator/cooler 912 at a temperature of approximately 150° C., where it is cooled to a temperature of approximately 70° C.

The hydrogen generator may further comprise ancillary components such as probes, sensors, additional control points, intelligent control points, cooling means, pumps and/or feedback means. These additional components may communicate with a control unit as described previously in order to measure, calibrate, optimise, influence and/or maintain certain quantities. These quantities may include reaction vessel pressure, dosage device levels, reaction vessel temperature, hydrogen stream temperature before passage through the separator/heat exchanger or after passage through the separator/heat exchanger, and water level in the cooling jacket.

The present invention has been described above in exemplary form with reference to the accompanying drawings which represent specific embodiments of the invention. It will be understood that many different embodiments of the invention exist, and that these embodiments all fall within the scope of the invention as defined by the appended claims.

1. A closed reactor for the generation of hydrogen gas from a chemical hydride comprising:
a reaction vessel;
at least one entry port; and
an outlet port for outputting hydrogen gas.

2. The reactor of claim 1, wherein the reactor further comprises a pressure gauge.

3. The reactor of claim 1, wherein a first portion of the reaction vessel is in the form of a truncated cone.

4. The reactor of claim 3, wherein a second portion of the reaction vessel is in the form of a truncated cone.

5. The reactor of claim 1, wherein the entry port is equipped with a fluid distributor and/or a cooling jacket that surrounds at least a portion of the reaction vessel.

6. (canceled)

7. The reactor of any claim 1, wherein the reaction vessel is a first reaction vessel, and wherein the reactor further comprises a second reaction vessel.

8. The reactor of claim 7, further comprising a first calibrated orifice between the first and second reaction vessels and/or a second calibrated orifice between the first reaction vessel and the outlet port.

9. (canceled)

10. The reactor of claim 8, further comprising a catalyst in communication with the first calibrated orifice.

11. The reactor of claim 1, further comprising a collector and/or a temperature gauge.

12. (canceled)

13. A hydrogen generator comprising:
a first reactor comprising the reactor of claim 1;
a first dosage device in communication with an entry port of the first reactor; and
a first hydrogen outlet in communication with the outlet port of the first reactor which is connectable to a fuel cell apparatus.

14. The hydrogen generator of claim 13, wherein the hydrogen generator further comprises a second dosage device in communication with an entry port of the first reactor.

15. The hydrogen generator of claim 13, wherein the first dosage device is a fluid dosage device.

16. The hydrogen generator of claim 15 wherein the fluid dosage device is in communication with an entry port of the first reactor equipped with a fluid distributor.

17. The hydrogen generator of claim 14, wherein the second dosage device is a chemical hydride dosage device.

18. The hydrogen generator of claim 13, wherein the hydrogen generator further comprises
a second reactor comprising the reactor of claim 1, wherein
at least one dosage device is in communication with an entry port of the second reactor; and
a hydrogen outlet is in communication with the outlet port of the second reactor which is connectable to a fuel cell apparatus.

19. The hydrogen generator of claim 18, wherein the fluid dosage device is in communication with an entry port of the second reactor.

20. The hydrogen generator of claim 19, wherein the first reactor and the second reactor are independently supplied with a fluid from the fluid dosage device.

21. The hydrogen generator of claim 19, wherein the fluid dosage device is in communication with an entry port of the second reactor equipped with a fluid distributor.

22. The hydrogen generator of claim 18, wherein the chemical hydride dosage device is in communication with an entry port of the second reactor.

23. The hydrogen generator of claim 22, wherein the first reactor and the second reactor are independently supplied with chemical hydride from the chemical hydride dosage device.

24. The hydrogen generator of claim 13, wherein the hydrogen outlet in communication with the outlet port of the second reactor is the first hydrogen outlet.

25. The hydrogen generator of claim 24, wherein the first reactor and the second reactor independently discharge hydrogen to the first hydrogen outlet.

26. The hydrogen generator of claim 13, wherein the hydrogen generator further comprises a separator and/or a heat exchanger in communication with the outlet port of the first reactor and the first hydrogen outlet.

27. The hydrogen generator of claim 26, wherein the separator and/or the heat exchanger comprise a vessel containing water.

28. The hydrogen generator of claim 27, wherein the vessel containing water is in fluid communication with the fluid dosage device.

29.-89. (canceled)
